(19) United States
(12) Patent Application Publication
(10) Pub. No.: US 2025/0133024 A1
(43) Pub. Date: Apr. 24, 2025

(54) DETERMINING OPTIMAL MULTIPATH NETWORK COST BASED ON TRAFFIC SEASONALITY

(71) Applicant: MELLANOX TECHNOLOGIES, LTD., Yokneam (IL)

(72) Inventors: Sharath Ramamurthy, Bengaluru (IN); Rohith Basavaraja, Bengaluru (IN); Vinay Prasad V, Bengaluru (IN)

(21) Appl. No.: 18/381,608

(22) Filed: Oct. 18, 2023

(51) Int. Cl. H04L 47/125; H04L 41/16; H04L 43/067; H04L 43/0882

(52) U.S. Cl. CPC H04L 47/125; H04L 41/16; H04L 43/067; H04L 43/0882

(57) ABSTRACT

A system, device, and method are provided. In one example, a method provides dynamic load balancing and adaptive packet routing. The method includes receiving traffic data associated with a physical data center fabric. The method also includes training a model using the received traffic data to predict a traffic pattern based on the received traffic data, and determining network weights based on the predicted traffic pattern and predicted seasonality of traffic, wherein the determined network weights are proactively applied to actual traffic in the physical data center fabric. The method further includes comparing network costs for the predicted traffic pattern to network costs for the actual traffic, and in response to the network costs for the predicted traffic pattern not matching the network costs for the actual traffic, triggering reinforcement learning of the model.

### FIELD OF THE DISCLOSURE

The present disclosure is generally directed toward networking and, in particular, toward systems, devices, and methods of operating the same.

### BACKGROUND

Devices including but not limited to personal computers, servers, or other types of computing devices may be interconnected using network devices such as switches. These interconnected entities form a network that enables data communication and resource sharing among the nodes. Often, multiple potential paths for data flow may exist between any pair of devices. This feature, often referred to as multipath routing, allows data, often encapsulated in packets, to traverse different routes from a source device to a destination device. Such a network design enhances the robustness and flexibility of data communication, as it provides alternatives in case of path failure, congestion, or other adverse conditions. Moreover, it facilitates load balancing across the network, optimizing the overall network performance and efficiency. However, managing multipath routing and ensuring optimal path selection can pose significant challenges, necessitating advanced mechanisms and algorithms for network control and data routing, and power consumption may be unnecessarily high, particularly during periods of low traffic.

### BRIEF SUMMARY

Load balancing of network traffic between multiple paths is conventionally a computationally difficult task. Consider a network switch receiving packets from one or more sources. Each packet flowing through the switch is associated with a particular destination. In simple topologies, there may be a single port of the switch which the packet must be sent from to reach the destination. However, in modern network topologies, there may be many possible ports from which a packet may be transmitted to reach an associated destination. As a result, a decision must be made as to which one of many possible ports should transmit each packet due to the existence of multiple paths in the network.

A goal of a switch in such a scenario in many applications is to route packets toward a destination in such a way as to provide maximal total throughput and avoiding congestion. As an example, consider two packets A and B being received by a switch S1. Packet A is targeted at a destination node X and packet B is targeted to a destination node Y. Switch S1 is connected to two other switches, S2 and S3. Switch S2 is connected to destination nodes X and Y, while switch S3 is connected to destination node X but not destination node Y.

To reach destination node X, packet A can be sent from S1 to S2 or S3. To reach destination node Y, packet B must be sent from S1 to S2. If both packets A and B are sent to their respective destinations from S1 to S2, a congestion may occur at S2 while S3 may be under-utilized. Also, if only one port connects S1 to S2, that port may be over-used while other ports remain unused. In such a scenario, one of the packets A and B may be delayed in reaching its respective destination. If, instead, packet A is sent from S1 to S3 and packet B from S1 to S2, then the packets may arrive at their respective destination without delay and without causing any congestion.

Conventional methods for routing traffic in high-performance computing (HPC) scenarios, such as large-scale or multi-tenant machine learning applications, rely on hash-based routing or other mechanisms which do not attempt to optimize the route of traffic. While such conventional methods may work for non-HPC cases involving small flows, such conventional methods are not optimized for scenarios involving large flows such as many Artificial Intelligence (AI) applications. Hash-based routing mechanisms result in artificial groupings of unrelated traffic which leads to inefficient and unstable routing. For example, as different flows are received by a conventional switch, the conventional switch assigns all packets in a particular flow to be routed via a particular port. When one flow includes a relatively large number of packets and/or when multiple flows are assigned to the same port, congestion, inefficient routing, and unstable routing can result.

Equal-cost multi-path routing (ECMP) is a routing strategy where packet forwarding to a single destination can occur over multiple best paths with equal routing priority. Multi-path routing can be used in conjunction with most routing protocols because it is a per-hop local decision made independently at each router. In ECMP, the route to a destination has multiple next hops and traffic is equally distributed across them. Flow-based hashing is used so that all traffic associated with a particular flow uses the same next hop and the same path across the network.

In unequal-cost multi-path routing (UCMP), along with the ECMP flow-based hash, a weight is associated with each next hop and traffic is distributed across the next hops in proportion to their weight. This mapping is a factoring of a particular path's bandwidth value against the total bandwidth values of all possible paths, mapped to the range 1 to 100.

The network routing strategy in any datacenter network or any telecommunication network comprises of one or more multiple paths of equal network cost (ECMP) for a given pair of source and destination. This achieves better load balancing, increased bandwidth, and high availability. Network deployments also support UCMP (unequal cost multi-path), however the weights/cost derivation for paths are-use specific and requires configuration.

ECMP treats traffic equally and relies on hashing algorithms to maintain flows and distribute the traffic across the equal cost paths. ECMP is a passive load balancing strategy that does not take into account the underlying link parameters such as queue depth, link utilization and so on, which causes some of the paths to be over/under utilized when the packet flows are highly polarized. An overutilized path can lead to network congestion as well affecting the traffic flows via those congested paths.

Dynamic Load Balancing or Adaptive Routing algorithms try to solve ECMP polarization by actively monitoring the link/queue parameters and adjusting the network cost of the multi paths. This is a method where network cost is adjusted constantly based on the link parameters considering the traffic flow characteristics. However, these methods are reactive in nature.

The present disclosure is directed to a proactively deriving optimal multi-path network cost for a physical data center fabric using a digital/simulated fabric. Using a simulated network fabric and artificial intelligence/machine learning (AI/ML) methods, the present disclosure proactively derives multi-path network cost derivation where traffic seasonality (e.g., time of day (TOD) pattern of traffic) is taken into consideration. For each network node from the physical world information is streamed to a simulated world (e.g., the simulated network fabric) as time series data. Examples of information streamed from the physical world include:
a. Configurations for each multi-path for time period T
b. Path weights configured for each multi-path for time period T
c. Link and path utilization for time period T
d. Queue parameters of each link. for time period T.

Using data streamed for the physical world, an ML model is trained to predict link and path utilization. Once trained, the model can be used to predict the traffic utilization for the given path and link, considering traffic seasonality. The predicted link and path utilization can then be used to derive optimal network weights for each of the multi-paths, taking into account the traffic seasonality. Traffic seasonality refers to the regular and predictable changes of the time series traffic data. In addition, other parameters such as link attributes, queue parameters, bandwidth utilization parameters, packet drops etc. may be considered.

The present disclosure is proactive in nature and uses AI/ML models to predict the weight derivations for each of the multi-paths based on the learnt traffic seasonality and network parameters and then to route traffic using the determined optimal weights for each multi-path at the network fabric level for a given time period. Actual traffic is then routed using the determined optimal weights for each multi-path, and a cost of routing the actual traffic is compared to a predicted cost, and if the predicted cost and the actual cost do not match, then reinforcement training is triggers on the ML model.

Referring now to FIGS. 1-4, various systems, and methods for routing packets between communication nodes will be described. The concepts of packet routing depicted and described herein can be applied to the routing of information from one computing device to another. The term packet as used herein should be construed to mean any suitable discrete amount of digitized information. The data being routed may be in the form of a single packet or multiple packets without departing from the scope of the present disclosure. Furthermore, certain embodiments will be described in connection with a system that is configured to make centralized routing decisions whereas other embodiments will be described in connection with a system that is configured to make distributed and possibly uncoordinated routing decisions. It should be appreciated that the features and functions of a centralized architecture may be applied or used in a distributed architecture or vice versa. The routing approach depicted and described herein may be applied to a switch, a router, or any other suitable type of networking device known or yet to be developed.

In an illustrative example, a method is disclosed that includes receiving traffic data associated with a physical data center fabric; training a model using the received traffic data to: predict a traffic pattern based on the received traffic data; determine network weights based on the predicted traffic pattern and predicted seasonality of traffic, wherein the determined network weights are proactively applied to the actual traffic in the physical data center fabric; comparing network costs for the predicted traffic pattern to network costs for the actual traffic; and in response to the network costs for the predicted traffic pattern not matching the network costs for the actual traffic, triggering reinforcement learning of the model.

In another example, a system is disclosed that includes an interface to receive traffic data associated with a physical data center fabric; and processing circuitry to: train a model using the received traffic data to: predict a traffic pattern based on the received traffic data; determine network weights based on the predicted traffic pattern and predicted seasonality of traffic, wherein the determined weights are proactively applied to the actual traffic in the physical data center fabric; and compare network costs for the predicted traffic pattern to network costs for the actual traffic.

In yet another example, a device is disclosed that includes processing circuitry to: predict a traffic pattern using a model trained with traffic data associated with a physical data center fabric; determine network weights based on the predicted traffic pattern and predicted seasonality of traffic, wherein the determined weights are proactively applied to actual traffic in the physical data center fabric.

Any of the above example aspects include wherein the traffic data comprises configurations of each multi-path in the physical data center fabric for a specified time period.

Any of the above example aspects include wherein the traffic data comprises path weights for each multi-path in the physical data center fabric for a specified time period.

Any of the above example aspects include wherein the traffic data comprises link and path utilization for a specified time period.

Any of the above example aspects include wherein the traffic data comprises queue parameters for each link for a specified time period.

Any of the above example aspects include wherein the traffic data comprises queue configuration parameters for a specified time period.

Any of the above example aspects include wherein the traffic data comprises bandwidth utilization parameters for a specified time period.

Any of the above example aspects include in response to the network costs for the predicted traffic pattern not matching the network costs for the actual traffic, triggering reinforcement learning of the model.

Any of the above example aspects include wherein the traffic data comprises configurations of each multi-path in the physical data center fabric for a specified time period.

Any of the above example aspects include wherein the traffic data comprises path weights for each multi-path in the physical data center fabric for a specified time period.

Any of the above example aspects include wherein the traffic data comprises link and path utilization for a specified time period.

Any of the above example aspects include wherein the traffic data comprises queue parameters for each link for a specified time period.

Any of the above example aspects include wherein the traffic data comprises queue configuration parameters for a specified time period.

Any of the above example aspects include wherein the traffic data comprises bandwidth utilization parameters for a specified time period.

Any of the above example aspects include wherein the network weights are determined based on optimal multi-path network costs.

Any of the above example aspects include wherein the traffic data comprises at least one of: configurations of each multi-path in the physical data center fabric, link and path utilization, queue parameters for each link, queue configuration parameters, and bandwidth utilization parameters.

Any of the above example aspects include wherein the network weights are determined based on optimal multi-path network costs.

Any of the above example aspects include wherein the processing circuitry is further configured to: compare network costs for the predicted traffic pattern to network costs for the actual traffic; and in response to the network costs for the predicted traffic pattern not matching the network costs for the actual traffic, triggering reinforcement learning of the model.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a multipath network in accordance with at least some embodiments of the present disclosure;

FIG. 2 is a block diagram depicting an illustrative configuration of a system to train a model for dynamic load balancing and adaptive packet routing in accordance with at least some embodiments of the present disclosure;

FIG. 3 is a flowchart depicting an illustrative configuration of a method in accordance with at least some embodiments of the present disclosure; and

FIG. 4 illustrates an example system for dynamic load balancing and adaptive packet routing in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

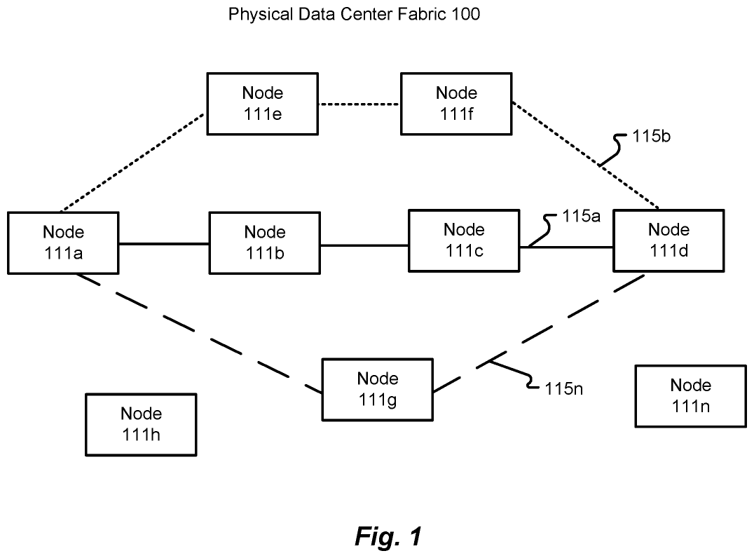

Referring now to FIGS. 1-4, various systems, and methods for dynamic load balancing and adaptive packet routing in a computing system will be described. The concepts of dynamic load balancing and adaptive packet routing depicted and described herein can be applied to any type of computing system capable of receiving and/or transmitting data. Such a computing system may be a router, but it should be appreciated any type of computing system may be used.

FIG. 1 depicts physical data center fabric 100. The physical data center fabric 100 includes nodes 111a-n and paths 115a-n. Nodes 111a-n may comprise devices such as switches, servers, personal computers, and other computing devices. Additional elements of the physical data center fabric 100 are not shown for clarity.

In embodiments, there are multipaths 115a-n between node 111a and 111d. The paths 115a-n may be used to transmit packets between the nodes. Each of the paths 115a-n may have different costs associated with it.

Each of the nodes 111a-n may include a processor that functions as the central processing unit of the node 111a-n and executes operative capabilities of the node 111a-n. The processor may communicate with other components of the node 111a-n.

The node 111a-n may also include one or more memory components which may store data such as configurations, path weights, link and path utilization, and queue parameters for each multi-path for time period T. Memory may be configured to communicate with the processor of the node 111a-n. Communication between memory and the processor may enable various operations, including but not limited to, data exchange, command execution, and memory management. In accordance with implementations described herein, memory may be used to store data, such as a routing algorithm, relating to the different network paths 115a-n.

The memory may be constituted by a variety of physical components, depending on specific type and design. Memory may include one or more memory cells capable of storing data in the form of binary information. Such memory cells may be made up of transistors, capacitors, or other suitable electronic components depending on the memory type, such as dynamic random-access memory (DRAM), static random-access memory (SRAM), or flash memory. To enable data transfer and communication with other parts of the node 111a-n, memory may also include data lines or buses, address lines, and control lines not illustrated in FIG. 1. Such physical components may collectively constitute the memory.

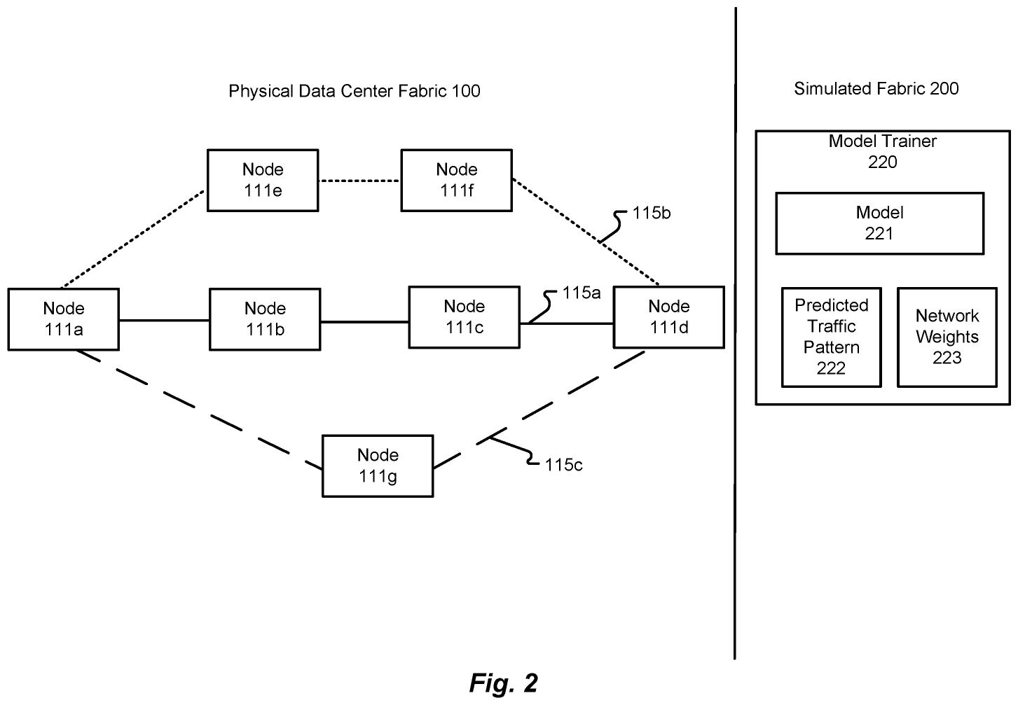

As illustrated in FIG. 2, information from the physical data center fabric 100 is transferred to the simulated fabric 200, to derive optimal multi-path network cost for the multi-paths 115a-n in the physical data center fabric 100. A model trainer 220 uses the traffic data from the physical data center fabric 100 to train a model 221. The model 221 is used to proactively derive multi-path network cost derivation where traffic seasonality is taken into consideration.

Using data streamed for the physical data center fabric 100, the ML model 221 is trained to predict a traffic pattern (e.g., link and path utilization) in the physical data center fabric 100. The predicted traffic pattern 222 may then be used to derive optimal network weights 223 for the multi paths 115a-n while also taking into account traffic seasonality. The optimal network weights 223 are used in the physical data center fabric 100 to route actual traffic. Once the actual traffic is routed using the optimal network weights 223, the network costs of routing the actual traffic is compared with the cost of the predicted traffic pattern 222, and if the cost of actual traffic is not the same (or relatively the same) as the predicted traffic pattern 222, reinforcement training of the ML model 221 is triggered and the process is repeated.

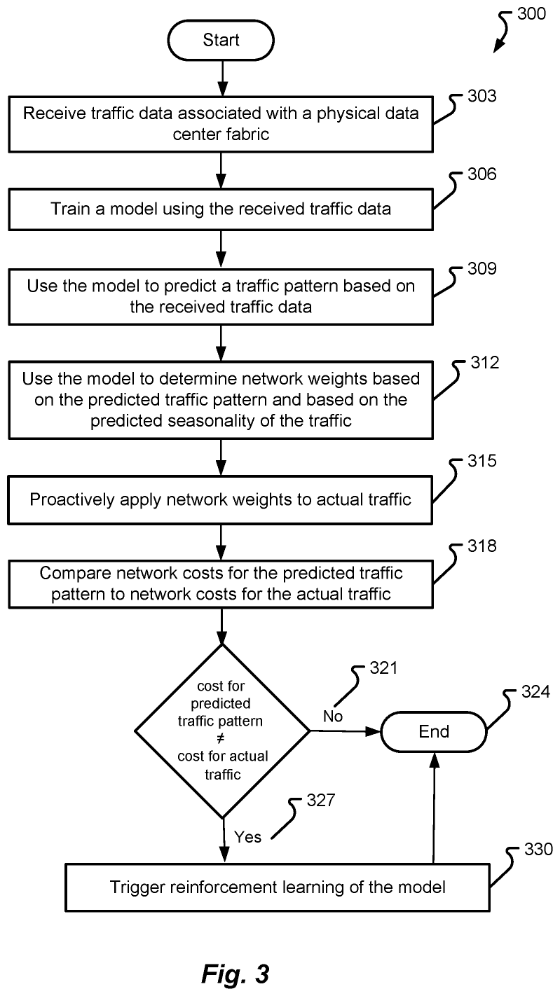

As illustrated in FIG. 3, a method 300 as described herein may be performed by a switch, router, or other computing device, in accordance with one or more of the embodiments described herein. The method 300 involves determining network weights based on the predicted traffic pattern and predicted seasonality of traffic and applying the network weights to actual traffic in the physical data center fabric 100. While the features of the method 300 are described as being performed by a node 111a-n, it should be appreciated that one or more of the functions may be performed by a processor, a switch, or any other computing device comprised by or in communication with a node 111a-n.

In some implementations, the method may be performed by a network device such as a network-interface card (NIC), a switch, a controller circuit of a switch, or any computing device. As such the systems and methods described herein may be used by any entity which uses a routing algorithm.

Information from the physical data center fabric 100 is transferred to the simulated fabric 200, to derive optimal multi-path network cost for the physical data center fabric 100. A model trainer 220 uses the data from the physical data center fabric 100 to train a model 221. The model 221 is used to proactively derive multi-path network cost using the predicted traffic pattern and traffic seasonality.

The process 300 starts, and at step 303, traffic data is received from the physical data center fabric 100. The data may include configurations for each multi-path for time period T, path weights configured for each multi-path for time period T, link and path utilization for time period T, queue parameters of each link for time period T, etc.

Using the traffic data received in step 303, the ML model 221 is trained to predict traffic patterns in step 306. In step 309, the trained model 221 predicts a traffic pattern (e.g., link and path utilization) in the physical data center fabric 100. In step 312, the predicted traffic pattern 222 may then be used to derive optimal network weights 223 for the multi-paths taking into account the traffic seasonality. In step 315, the optimal network weights 223 are proactively applied to actual traffic in the physical data center fabric 100. Once the actual traffic is routed using the optimal network weights 223, in step 318, the network costs of routing the actual traffic are compared with the cost of the predicted traffic pattern 222. If the network cost of the actual traffic is the same (or approximately the same) as the cost of the predicted traffic pattern (step 321, “No”), then the process 300 ends (step 324). If the cost of actual traffic is not the same as the predicted traffic pattern 222 (step 327, “Yes”), in step 330 reinforcement training of the ML model 221 is triggered.

In one or more embodiments of the present disclosure, the method 300, after executing, may return to 303 and recommence the process. In some implementations, the repetition of method 300 may occur without delay. In such cases, as soon as the method 300 concludes, the method 300 may immediately begin the next iteration. This arrangement could allow for a continuous execution of method 300. In some implementations, a pause for a predetermined amount of time may occur between successive iterations of method 300. The duration of the pause may be specified as per the operational needs of the method such as by a user.

The present disclosure encompasses methods with fewer than all of the steps identified in FIG. 3 (and the corresponding description of the method), as well as methods that include additional steps beyond those identified in FIG. 3 (and the corresponding description of the method). The present disclosure also encompasses methods that comprise one or more steps from the methods described herein, and one or more steps from any other method described herein.

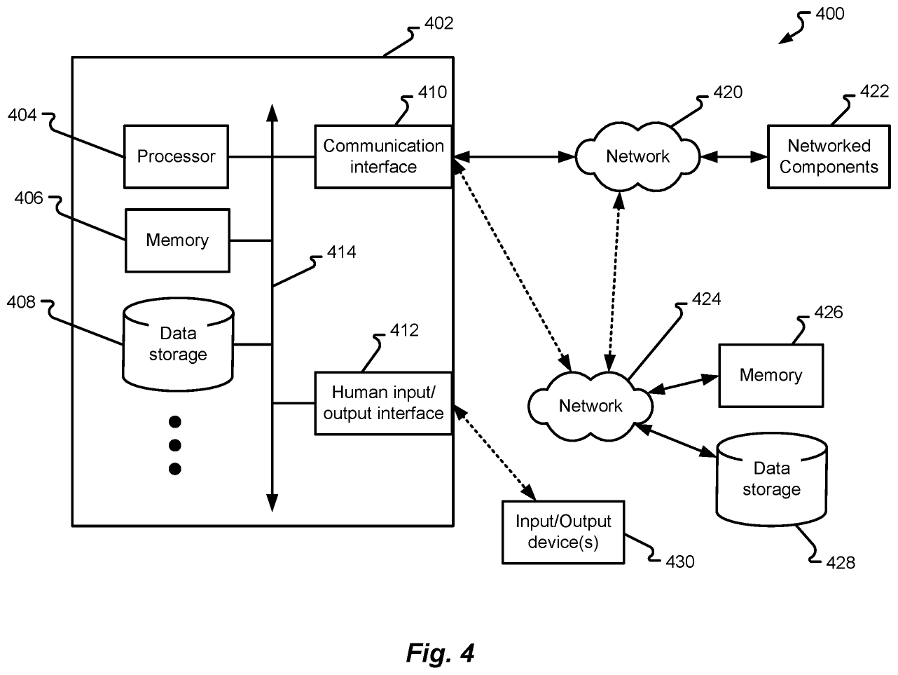

FIG. 4 depicts device 402 in system 400 in accordance with embodiments of the present disclosure. Device 402 may be an example of the nodes 111a-n.

The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414.

In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize memory 406 and/or data storage 408 for the storage of accessible data, such as instructions, values, etc. Communication interface 410 facilitates communication with components, such as processor 404 via bus 414 with components not accessible via bus 414. Communication interface 410 may be embodied as a network port, card, cable, or other configured hardware device. Additionally, or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or utilize one or more networks, such as network 420 and/or network 424. Input/output device(s) 430 may be accessed by processor 404 via human input/output interface 412 and/or via communication interface 410 either directly, via network 424 (not shown), via network 420 alone (not shown), or via networks 424 and 420 (not shown).

Networks 420 and 424 may be a wired network (e.g., Ethernet), wireless (e.g., Wi-Fi, Bluetooth, cellular, etc.) network, or combination thereof and enable device 402 to communicate with networked component(s) 422 (e.g., automation system). In other embodiments, networks 420 and/or 424 may be embodied, in whole or in part, as a telephony network (e.g., public switched telephone network (PSTN), private branch exchange (PBX), cellular telephony network, etc.).

Components attached to network 424 may include memory 426 and data storage 428. For example, memory 426 and/or data storage 428 may supplement or supplant memory 406 and/or data storage 408 entirely or for a particular task or purpose. For example, memory 426 and/or data storage 428 may be an external data repository (e.g., server farm, array, “cloud,” etc.) and allow device 402, and/or other devices, to access data thereon. Each of memory 406 and data storage 408, memory 426, data storage 428 comprise a non-transitory data storage comprising a data storage device.

Embodiments of the present disclosure include a method to provide dynamic load balancing and adaptive packet routing, the method comprising: receiving traffic data associated with a physical data center fabric; training a model using the received traffic data to: predict a traffic pattern based on the received traffic data; determine network weights based on the predicted traffic pattern and predicted seasonality of traffic, wherein the determined network weights are proactively applied to the actual traffic in the physical data center fabric; comparing network costs for the predicted traffic pattern to network costs for the actual traffic; and in response to the network costs for the predicted traffic pattern not matching the network costs for the actual traffic, triggering reinforcement learning of the model.

Embodiments of the present disclosure also include a system to provide dynamic load balancing and adaptive packet routing, the system comprising: an interface to receive traffic data associated with a physical data center fabric; and processing circuitry to: train a model using the received traffic data to: predict a traffic pattern based on the received traffic data; determine network weights based on the predicted traffic pattern and predicted seasonality of traffic, wherein the determined network weights are proactively applied to the actual traffic in the physical data center fabric; and compare network costs for the predicted traffic pattern to network costs for the actual traffic.

Embodiments of the present disclosure also include a device to provide dynamic load balancing and adaptive packet routing, the device comprising: processing circuitry to: predict a traffic pattern using a model trained with traffic data associated with a physical data center fabric; determine network weights based on the predicted traffic pattern and predicted seasonality of traffic, wherein the determined weights are proactively applied to actual traffic in the physical data center fabric.

Aspects of the above system, device, and/or method include wherein the traffic data comprises configurations of each multi-path in the physical data center fabric for a specified time period.

Aspects of the above system, device, and/or method include wherein the traffic data comprises path weights for each multi-path in the physical data center fabric for a specified time period.

Aspects of the above system, device, and/or method include wherein the traffic data comprises link and path utilization for a specified time period.

Aspects of the above system, device, and/or method include wherein the traffic data comprises queue parameters for each link for a specified time period.

Aspects of the above system, device, and/or method include wherein the traffic data comprises queue configuration parameters for a specified time period.

Aspects of the above system, device, and/or method include wherein the traffic data comprises bandwidth utilization parameters for a specified time period.

Aspects of the above system, device, and/or method include further comprising: in response to the network costs for the predicted traffic pattern not matching the network costs for the actual traffic, triggering reinforcement learning of the model.

Aspects of the above system, device, and/or method include wherein the traffic data comprises configurations of each multi-path in the physical data center fabric for a specified time period.

Aspects of the above system, device, and/or method include wherein the traffic data comprises path weights for each multi-path in the physical data center fabric for a specified time period.

Aspects of the above system, device, and/or method include wherein the traffic data comprises link and path utilization for a specified time period.

Aspects of the above system, device, and/or method include wherein the traffic data comprises queue parameters for each link for a specified time period.

Aspects of the above system, device, and/or method include wherein the traffic data comprises queue configuration parameters for a specified time period.

Aspects of the above system, device, and/or method include wherein the traffic data comprises bandwidth utilization parameters for a specified time period.

Aspects of the above system, device, and/or method include wherein the network weights are determined based on optimal multi-path network costs.

Aspects of the above system, device, and/or method include wherein the traffic data comprises at least one of: configurations of each multi-path in the physical data center fabric, link and path utilization, queue parameters for each link, queue configuration parameters, and bandwidth utilization parameters.

Aspects of the above system, device, and/or method include wherein the network weights are determined based on optimal multi-path network costs.

Aspects of the above system, device, and/or method include wherein the processing circuitry is further configured to: compare network costs for the predicted traffic pattern to network costs for the actual traffic; and in response to the network costs for the predicted traffic pattern not matching the network costs for the actual traffic, triggering reinforcement learning of the model.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

1. A method to provide dynamic load balancing and adaptive packet routing, the method comprising:
in a simulated network fabric, receiving traffic data associated with a physical data center fabric for a specified time period;
in the simulated network fabric, training a model using the received traffic data for the specified time period to:
predict a traffic pattern for the specified time period; and
determine network weights based on the predicted traffic pattern for the specified time period and predicted seasonality of traffic, wherein the determined network weights are proactively applied to actual traffic during the specified time period;
in the physical data center fabric, routing the actual traffic using the determined network weights for each multi-path for the specified time period;
comparing network costs for the predicted traffic pattern for the specified time period to network costs for the actual traffic in the physical data center fabric during the specified time period; and
in response to the network costs for the predicted traffic pattern at the specified time period not matching the network costs for the actual traffic at the specified time period, triggering reinforcement learning of the model.

2. The method of claim 1, wherein the traffic data comprises configurations of each multi-path in the physical data center fabric for a specified time period.

3. The method of claim 1, wherein the traffic data comprises path weights for each multi-path in the physical data center fabric for a specified time period.

4. The method of claim 1, wherein the traffic data comprises link and path utilization for a specified time period.

5. The method of claim 1, wherein the traffic data comprises queue parameters for each link for a specified time period.

6. The method of claim 1, wherein the traffic data comprises queue configuration parameters for a specified time period.

7. The method of claim 1, wherein the traffic data comprises bandwidth utilization parameters for a specified time period.

8. A system to provide dynamic load balancing and adaptive packet routing, the system comprising:
an interface to receive traffic data associated with a physical data center fabric for a specified time period; and
processing circuitry to:
train a model using the received traffic data to:
predict a traffic pattern for the specified time period;
determine network weights based on the predicted traffic pattern for the specified time period and predicted seasonality of traffic, wherein the determined network weights are proactively applied to actual traffic during the specified time period;
route the actual traffic using the determined network weights for each multi-path for the specified time period; and
compare network costs for the predicted traffic pattern for the specified time period to network costs for the actual traffic in the physical data center fabric at the specified time period.

9. The system of claim 8, further comprising:
in response to the network costs for the predicted traffic pattern not matching the network costs for the actual traffic, triggering reinforcement learning of the model.

10. The system of claim 8, wherein the traffic data comprises configurations of each multi-path in the physical data center fabric for a specified time period.

11. The system of claim 8, wherein the traffic data comprises path weights for each multi-path in the physical data center fabric for a specified time period.

12. The system of claim 8, wherein the traffic data comprises link and path utilization for a specified time period.

13. The system of claim 8, wherein the traffic data comprises queue parameters for each link for a specified time period.

14. The system of claim 9, wherein the traffic data comprises queue configuration parameters for a specified time period.

15. The system of claim 9, wherein the traffic data comprises bandwidth utilization parameters for a specified time period.

16. The system of claim 8, wherein the network weights are determined based on optimal multi-path network costs.

17. A device to provide dynamic load balancing and adaptive packet routing, the device comprising:
processing circuitry to:
predict a traffic pattern for a specified time period using a model trained with traffic data associated with a physical data center fabric for the specified time period;
determine network weights based on the predicted traffic pattern for the specified time period and predicted seasonality of traffic, wherein the determined network weights are proactively applied to actual traffic in the physical data center fabric during the specified time period;
route the actual traffic using the determined network weights for each multi-path for the specified time period; and
compare network costs for the predicted traffic pattern for the specified time period to network costs for the actual traffic in the physical data center fabric during the specified time period.

18. The device of claim 17, wherein the traffic data comprises at least one of: configurations of each multi-path in the physical data center fabric, link and path utilization, queue parameters for each link, queue configuration parameters, and bandwidth utilization parameters.

19. The device of claim 17, wherein the network weights are determined based on optimal multi-path network costs.

20. The device of claim 17, wherein the processing circuitry is further configured to:
compare network costs for the predicted traffic pattern to network costs for the actual traffic; and
in response to the network costs for the predicted traffic pattern not matching the network costs for the actual traffic, trigger reinforcement learning of the model.
